(19) United States
(12) Patent Application Publication
(10) Pub. No.: US 2005/0184851 A1
(43) Pub. Date: Aug. 25, 2005

(54) Independently housed trim resistor and a method for fabricating same

(75) Inventor: Charles Scott Nelson, Clio, MI (US)

Correspondence Address: DELPHI TECHNOLOGIES, INC., M/C 480-410-202, PO BOX 5052, TROY, MI, 48007, US

(73) Assignee: Delphi Technologies, Inc.

(21) Appl. No.: 11/118,153

(22) Filed: Apr. 29, 2005

Related U.S. Application Data
(62) Division of application No. 10/472,409, filed on Sep. 17, 2003.
(60) Provisional application No. 60/277,037, filed on Mar. 19, 2001.

(51) Int. Cl. H01C 10/00

(52) U.S. Cl. 338/195

(57) ABSTRACT

An independently housed trim resistor including a trim resistor having a resistive element and a plurality of conductive pads, wherein the plurality of conductive pads are disposed so as to be communicated with the resistive element, a plurality of lead wires, wherein the plurality of lead wires are disposed so as to be communicated with and terminated at the plurality of conductive pads and a resistor housing, the resistor housing having a housing body and a housing top, wherein the housing body defines a resistor cavity for containing the trim resistor and wherein the housing top includes a trim opening disposed so as to allow communication with the resistive element and a method for fabricating an independently housed trim resistor including obtaining a first lead wire, a second lead wire and a trim resistor, wherein the trim resistor includes a resistive element and a plurality of conductive pads, obtaining a resistor housing having a housing top and a housing body, wherein the housing body defines a resistor cavity, arranging the first lead wire and the second lead wire so as to be communicated with the plurality of conductive pads, arranging the trim resistor so as to be disposed within the resistor cavity, arranging the housing top relative to the housing body so as enclose the resistor cavity, connecting the housing top to the housing body and adjusting the resistive element so as to achieve a desired resistance.

### BACKGROUND

Some exhaust sensors need a compensation resistor to tell the electronics how to compensate for part-to-part variability in the sensor itself. There are two ways to do this, first using a discrete fixed resistor. A fixed value resistor requires a very large collection of resistors in which the manufacturer must pick a resistor that is closest in value to the required resistance. This will almost never allow for a perfect match and requires many different part numbers. The second way of compensation is to use a trim resistor, which requires a laser to burn a resistive surface until the exact resistance is achieved. This requires only one part number and perfectly matches the desired resistance. The current method of attaching trim resistors to sensors is to integrate the trim resistor into the off end connector. While this is compact, it is not flexible to customers needs if they wish to use a different connector.

### BRIEF SUMMARY

An independently housed trim resistor comprising: a trim resistor having a resistive element and a plurality of conductive pads, wherein the plurality of conductive pads are disposed so as to be communicated with the resistive element; a plurality of lead wires, wherein the plurality of lead wires are disposed so as to be communicated with and terminated at the plurality of conductive pads; and a resistor housing, the resistor housing having a housing body and a housing top, wherein the housing body defines a resistor cavity for containing the trim resistor and wherein the housing top includes a trim opening disposed so as to allow communication with the resistive element.

A method for fabricating an independently housed trim resistor comprising: obtaining a first lead wire, a second lead wire and a trim resistor, wherein the trim resistor includes a resistive element and a plurality of conductive pads; obtaining a resistor housing having a housing top and a housing body, wherein the housing body defines a resistor cavity; arranging the first lead wire and the second lead wire so as to be communicated with the plurality of conductive pads; arranging the trim resistor so as to be disposed within the resistor cavity; arranging the housing top relative to the housing body so as enclose the resistor cavity; connecting the housing top to the housing body; and adjusting the resistive element so as to achieve a desired resistance.

### BRIEF DESCRIPTION OF THE DRAWINGS

The present invention will now be described, by way of an example, with references to the accompanying drawings, wherein like elements are numbered alike in the several figures in which:

FIG. 1 shows an exploded perspective view of an independently housed trim resistor in accordance with an exemplary embodiment;

FIG. 2 shows a perspective view of an independently housed trim resistor in accordance with an exemplary embodiment;

FIG. 3 shows a top down view of a trim resistor in accordance with an exemplary embodiment;

FIG. 4 shows a block diagram describing a method for fabricating an independently housed trim resistor in accordance with an exemplary embodiment;

FIG. 5 shows a cross sectional view of an example of an independently housed trim resistor disposed within a sensor wire sheath in accordance with an exemplary embodiment; and

FIG. 6 shows an example of a final sensor assembly which employs an independently housed trim resistor in accordance with an exemplary embodiment.

### DETAILED DESCRIPTION OF AN EXEMPLARY EMBODIMENT

Referring to the figures, an independently housed trim resistor 1 is provided that advantageously allows for a wide range of devices to employ a trim resistor by providing a novel trim resistor design that can be used with a variety of circuit connectors inexpensively and effectively.

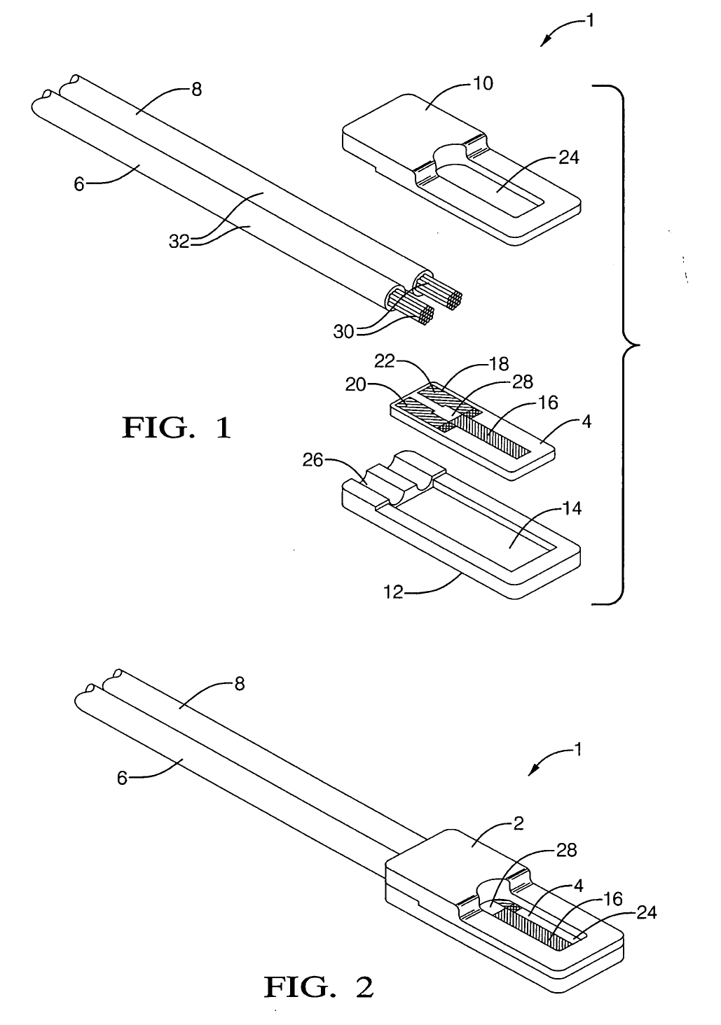

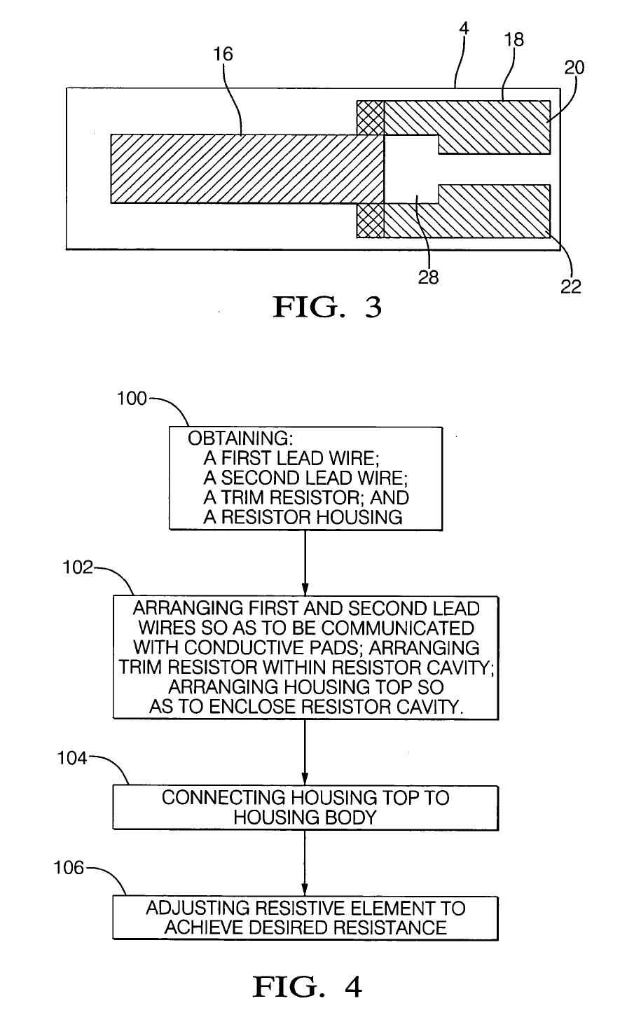

Referring to the drawings, FIG. 1 and FIG. 2 show independently housed trim resistor 1 having a resistor housing 2, a trim resistor 4 and a plurality of lead wires 5 including a first lead wire 6 and a second lead wire 8 in accordance with an exemplary embodiment. Resistor housing 2 preferably includes a housing top 10 and a housing body 12, wherein housing body 12 defines a resistor cavity 14 for containing trim resistor 4. Referring to FIG. 3, a trim resistor 4 is shown in accordance with an exemplary embodiment. Trim resistor 4 preferably includes a resistive element 16 and a plurality of conductive pads 18 having a first pad 20 and a second pad 22, wherein the plurality of conductive pads 18 are communicated with resistive element 16 so as to cause an electrical resistance between first pad 20 and second pad 22.

In accordance with an exemplary embodiment, resistive element 16, first pad 20 and second pad 22 are preferably disposed so as to create an open area 28 adjacent to resistive element 16. In addition, housing top 10 preferably includes a trim opening 24 disposed so as to allow communication with resistive element 16 and open area 28. Moreover, resistor housing 2 preferably includes a pad opening 26 disposed so as to be communicated with plurality of conductive pads 18. First lead wire 6 and second lead wire 8 preferably includes a conductive core 30 and protective sheath 32 encasing conductive core 30. In accordance with an exemplary embodiment, first lead wire 6 is preferably disposed such that conductive core 30 is communicated with first pad 20 and second lead wire 8 is preferably disposed such that conductive core 30 is communicated with second pad 22. In addition, first lead wire 6 and second lead wire 8 are preferably disposed so as to terminate at first pad 20 and second pad 22, respectively.

In accordance with an exemplary embodiment, first lead wire 6 and second lead wire 8 may be any wire suitable to the desired end purpose.

In accordance with an exemplary embodiment, housing top 10 is preferably non-movably associated with housing body 12 so as to enclose resistor cavity 14. In addition, resistive element 16 is preferably removably associated with trim resistor 4.

Referring to the figures, a method for fabricating an independently housed trim resistor 1 as described hereinabove is illustrated and discussed. In accordance with an exemplary embodiment, a first lead wire 6, a second lead wire 8, a trim resistor 4 having a resistive element 16 and a plurality of conductive pads 18 and a resistor housing 2 having a housing top 10 and a housing body 12 are obtained as shown in step 100. In accordance with an exemplary embodiment, resistor housing 2 preferably includes a pad opening 26 disposed so as to allow communication with said plurality of conductive pads 18. In addition, housing top 10 preferably includes a trim opening 24.

First lead wire 6 and second lead wire 8 are then arranged so as to be communicated with plurality of conductive leads 18 via pad opening 26, wherein first lead wire 6 is communicated with first pad 20 and second lead wire 8 is communicated with second pad 22, as shown in step 102. Trim resistor 4 is then arranged so as to be disposed within resistor cavity 14 such that resistive element 16 is directed away from housing body 12 and housing top 10 is then arranged so as to cover trim resistor 4 and enclose resistor cavity 14, also as shown in step 102. In accordance with an exemplary embodiment, housing top 10 is preferably disposed relative to trim resistor 4 so as to allow communication with resistive element 16 via trim opening 24. Also, housing top 10 is preferably disposed relative to housing body 12 so as to cause first lead wire 6 and second lead wire 8 to be compressingly and non-movably associated with plurality of conductive pads 18. Moreover, housing top 10 is preferably arranged relative to housing body 12 so as to non-movably contain trim resistor 4 within resistor cavity 14.

Once all of the components of independently housed trim resistor 1 have been arranged as shown in step 102, housing top 10 is then connected to housing body 12 as shown in step 104. In accordance with an exemplary embodiment, housing top 10 is preferably ultrasonically welded to housing body 12 so as to create a seal between housing top 10 and housing body 12. In addition, housing top 10 is preferably ultrasonically welded to housing body 12 so as to create a seal between first lead wire 6 and resistor housing 2 and between second lead wire 8 and resistor housing 2. Although housing top 10 is preferably connected to housing body 12 via ultrasonic welding, housing top 10 may be connected to housing body 12 using any method suitable to the desired end purpose. This process creates a high normal force crimp on the bare wire of first lead wire 6 and second lead wire 8 to trim resistor 4.

Once housing top 10 has been connected to housing body 12 as shown in step 104, resistive element 16 is adjusted so as to achieve a desired resistance between first pad 20 and second pad 22, as shown in step 106. In accordance with an exemplary embodiment, resistive element 16 is preferably adjusted via laser trimming. This is preferably done by communicating a laser beam with a predetermined starting position within open area 28 of trim resistor 4 via trim opening 24. In accordance with an exemplary embodiment, the laser would preferably find its proper starting location by finding the predetermined starting position disposed somewhere within open area 28 of trim resistor 4. However, the laser may find its proper starting location by locating two edges that are ninety degrees apart from each other or by finding the top and either the right or left edge of resistive element 16.

Once the laser has been communicated with the predetermined starting position, the laser beam then removes a portion of resistive element 16 by cutting into resistive element 16 until a desired resistance is achieved between first pad 20 and second pad 22. In accordance with an exemplary embodiment, additional laser cuts may be used to further refine the resistance. Once the desired resistance has been achieved, an adhesive coating may be applied to housing top 10 so to create a protective seal to the area within trim opening 24. In accordance with an exemplary embodiment adhesive coating may be any adhesive coating having non-conductive properties capable of bonding to resistor housing 2 so as to form a watertight seal, such as an acrylic encapsulate.

In accordance with an exemplary embodiment, the resistance of resistive element 16 may be measured via a passive trim approach or via an active trim approach. One type of passive trim measurement approach, which may or may not be performed during the lasing process, measures the resistance of resistive element 16 by probing either first pad 20 and second pad 22 and/or first lead wire 6 and second lead wire 8, using any resistance measurement device suitable to the desired end purpose. If the resistance is being measured during the lasing process, the laser will terminate lasing once a desired resistance is achieved. If the resistance is not being measured during the lasing process, the resistance will be measured following a laser cut. If the resistance is not as desired, the lasing processes will be repeated until a desired resistance is achieved. Another type of passive trim measurement approach would be to calculate, using the property characteristics of resistive element 16, how much of the resistive element 16 must be removed in order to achieve a desired resistance. Once this is calculated, the laser may be precisely controlled to remove the calculated quantity.

In accordance with an exemplary embodiment, under an active trim measurement approach, which also may or may not be performed during the lasing process, independently housed trim resistor 1 is connected to a desired device, such as a sensor. A known condition is applied to the input of the device and the output of the device is monitored. The resistance of resistive element 16 is then adjusted, as discussed hereinabove, until a desired output of the device is achieved.

In accordance with an exemplary embodiment, although resistance of resistive element 16 is explained hereinabove as being adjusted using a laser, the resistance of resistive element 16 may be adjusted using any suitable adjustment method or device, such as sandblasting or water cutting. In addition, the laser used to adjust resistive element 16 may be any laser that abates material.

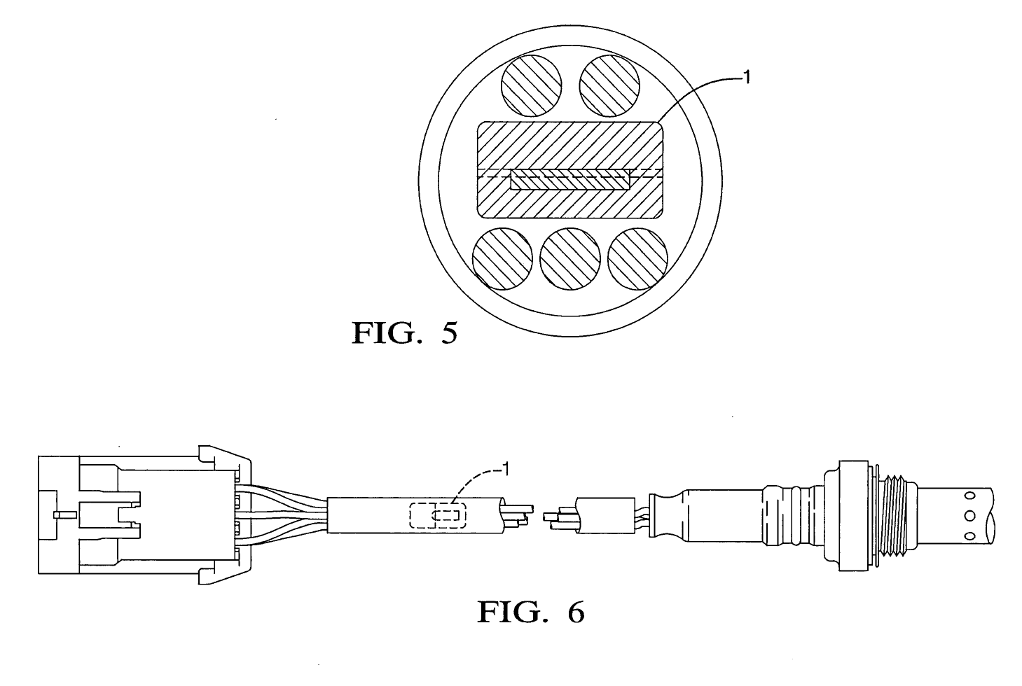

In accordance with an exemplary embodiment, wire terminations may be applied to first lead wire 6 and second lead wire 8 so as to allow independently housed trim resistor 1 to be communicated with external devices, such as wide range sensors. Independently housed trim resistor 1 may then be secured using any suitable retention method, such as tape or inserting independently housed trim resistor 1 into a wire protection sheath along with other device wires as shown in FIG. 5 and FIG. 6.

In accordance with an exemplary embodiment, trim resistor 4 is preferably constructed of a ceramic substrate. However, trim resistor 4 may be constructed of any material suitable to the desired end purpose.

In accordance with an exemplary embodiment, resistive element 16 is preferably constructed of printed resistor ink, such as ruthenium oxide. However, resistive element 16 may be constructed of any resistive material suitable to the desired end purpose.

In accordance with an exemplary embodiment, first pad 20 and second pad 22 are preferably constructed using a conductive ink constructed of a conductive material, such as palladium. However, first pad 20 and second pad 22 may be constructed of any conductive material that resists oxidation and that is suitable to the desired end purpose.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An independently housed trim resistor comprising:
a trim resistor having a resistive element and a plurality of conductive pads, wherein said plurality of conductive pads are disposed so as to be communicated with said resistive element;
a plurality of lead wires, wherein said plurality of lead wires are disposed so as to be communicated with and terminated at said plurality of conductive pads; and
a resistor housing, said resistor housing having a housing body and a housing top, wherein said housing body defines a resistor cavity for containing said trim resistor and wherein said housing top includes a trim opening disposed so as to allow communication with said resistive element.

2. An independently housed trim resistor according to claim 1, wherein said trim resistor is constructed of a ceramic substrate.

3. An independently housing trim resistor according to claim 1, wherein said resistive element is removably associated with said trim resistor.

4. An independently housed trim resistor according to claim 1, wherein said resistor housing further includes a pad opening disposed so as to allow communication with said plurality of conductive pads.

5. An independently housed trim resistor according to claim 4, wherein said plurality of lead wires include a first lead wire and a second lead wire, wherein said first lead wire is disposed so as to be communicated with at least one of said plurality conductive pads via said pad opening and wherein said second lead wire is disposed so as to be communicated with the other of said plurality of conductive pads via said pad opening.

6. An independently housing trim resistor according to claim 5, wherein said plurality of lead wires are non-movably associated with said plurality of conductive pads.

7. An independently housed trim resistor according to claim 1, wherein said housing top is disposed so as to be non-movably associated with said housing body.

8. An independently housed trim resistor according to claim 1, wherein said plurality of conductive pads are communicated with said resistive element so as to cause a resistance between said plurality of conductive pads.

9. An independently housed trim resistor according to claim 1, wherein said resistive element is constructed of resistive ink.

10. An independently housed trim resistor according to claim 1, wherein said plurality of conductive pads are constructed of conductive ink.

11. An independently housed trim resistor according to claim 1, wherein said resistor housing is constructed of a plastic material.

12. A method for fabricating an independently housed trim resistor comprising:
obtaining a first lead wire, a second lead wire and a trim resistor, wherein said trim resistor includes a resistive element and a plurality of conductive pads;
obtaining a resistor housing having a housing top and a housing body, wherein said housing body defines a resistor cavity;
arranging said first lead wire and said second lead wire so as to be communicated with said plurality of conductive pads;
arranging said trim resistor so as to be disposed within said resistor cavity;
arranging said housing top relative to said housing body so as enclose said resistor cavity;
connecting said housing top to said housing body; and
adjusting said resistive element so as to achieve a desired resistance.

13. The method of claim 12, wherein said obtaining includes obtaining said resistor housing wherein said resistor housing includes a pad opening disposed so as to allow communication with said plurality of conductive pads.

14. The method of claim 13, wherein said arranging includes arranging said first lead wire and said second lead wire so as to be communicated with said plurality of conductive pads via said pad opening.

15. The method of claim 12, wherein said obtaining includes obtaining a housing top wherein said housing top includes a trim opening.

16. The method of claim 15, wherein said arranging includes arranging said housing top relative to said trim resistor so as to allow communication with said resistive element via said trim opening.

17. The method of claim 12, wherein said arranging includes arranging said housing top relative to said housing body so as to cause said first lead wire and said second lead wire to be non-movably associated with said plurality of conductive pads.

18. The method of claim 12, wherein said arranging include arranging said housing top relative to said housing body so as to non-movably contain said trim resistor within said resistor cavity.

19. The method of claim 12, wherein said connecting includes ultrasonically welding said housing top to said housing body so as to create a seal between said housing top and said housing body.

20. The method of claim 12, wherein said connecting includes ultrasonically welding said housing top to said housing body so as to create a seal between said first lead wire and said resistor housing.

21. The method of claim 12, wherein said connecting includes ultrasonically welding said housing top to said housing body so as to create a seal between said second lead wire and said resistor housing.

22. The method of claim 12, wherein said adjusting includes removing a portion of said resistive element.

23. The method of claim 12, wherein said adjusting includes applying a laser to said resistive element via said trim opening so as to remove a portion of said resistive element.

24. The method of claim 12, wherein said adjusting includes measuring the resistance of said resistive element.

25. The method of claim 12, wherein said adjusting includes calculating the resistance of said resistive element.

26. The method of claim 15, wherein said adjusting includes applying an adhesive coating to said housing top so to seal said trim opening.

27. An independently housed trim resistor comprising:
a trim resistor having a resistive element and a plurality of conductive pads, wherein said plurality of conductive pads are disposed so as to be communicated with said resistive element; and
a resistor housing defining a resistor cavity for containing said trim resistor, wherein said resistor housing includes a pad opening and a trim opening, wherein said trim opening is dispose so as to allow communication with said trim resistor and wherein said pad opening is disposed so as to allow communication with said plurality of conductive pads.
